(19) United States
(12) Patent Application Publication
(10) Pub. No.: US 2017/0043467 A1
(43) Pub. Date: Feb. 16, 2017

(54) KEY-SHAPED MULTI-TOOL DEVICE

(71) Applicant: Narbeh Arakelian, Glendale, CA (US)

(72) Inventor: Narbeh Arakelian, Glendale, CA (US)

(21) Appl. No.: 14/861,982

(22) Filed: Sep. 22, 2015

Related U.S. Application Data
(60) Provisional application No. 62/205,124, filed on Aug. 14, 2015.

(51) Int. Cl. B25F 1/00; B26B 11/00

(52) U.S. Cl. CPC B25F 1/00; B26B 11/00

(57) ABSTRACT

A key-shaped multi-tool device is presented. The invention is a multi-tool device that incorporates several tools used in everyday functions into a simple sturdy key-shaped device. The key-shaped device comprises a head section and a tail section. The head section comprises an opening with at least one section shaped to operate as a Hex wrench. The device further comprises a first cavity on the front side which is preferably shaped for use as a hex wrench and as a bottle opener. The tail section comprises a semi-sharp cutting blade that is safe to the touch. The tail section further comprises a claw from its proximal end to an adjoining a second cavity near its mid-section. The claw is such that it could be used for multiple functions. The second cavity is shaped as a Hex wrench.

### CROSS-REFERENCE TO RELATED APPLICATIONS

The present application claims the benefit of U.S. Provisional Application Ser. No. 62/205,124, filed on Aug. 14, 2015, specification of which are herein incorporated by reference for completeness of disclosure.

### BACKGROUND OF THE INVENTION

Field of the Invention

Embodiments of the invention relates to the field of mechanical tools. More specifically, the invention relates to a key-shaped multi-tool device.

Description of the Related Art

A multi-tool is any one of a range of portable, versatile hand tools that combines several individual functions in a single device. The smallest are credit-card or key sized units designed for carrying in a wallet or on key chains, but others are designed to be carried in a person's pocket or on belt-mounted pouch.

Prior art key-sized multi-tools have very limited functionality included in each device and are usually not key shaped.

### BRIEF SUMMARY OF THE INVENTION

One or more embodiments of the invention are directed a key-shaped multi-tool device. The present invention comprises a multi-tool device that incorporates several tools used in everyday functions into a simple sturdy key-shaped device.

One or more embodiments of the present invention comprise a key-shaped device with a head section and a tail section. The head section comprises an opening with at least one section shaped to operate as a Hex wrench. For instance, the opening may be configured as a combination of a 10 mm Hex wrench, an 8 mm Hex wrench, and a 6 mm Hex wrench.

In one or more embodiments, the device further comprises a first cavity on the front side which is preferably shaped as a hex wrench at one end. For instance, the distal end may be configured as a 5 mm Hex wrench or any other suitable wrench dimension.

In one or more embodiments, the length of the first cavity includes an edge such that it may be used as a bottle opener, or for other purposes.

In one or more embodiments, tail section comprises a cutting blade. The cutting blade is preferably a semi-sharp blade such that it would be safe to touch with a person's hand.

In one or more embodiments, the tail section further comprises a slot from its proximal end to an adjoining a second cavity. The slot is configured as a claw such that it could be used for multiple functions, for instance, canister lid opener, can opener, staple remover, etc.

In one or more embodiments, the second cavity in tail section is preferably shaped as a Hex wrench. For instance, the cavity may be configured as a 4 mm Hex wrench or any other suitable dimension or use.

### BRIEF DESCRIPTION OF THE DRAWINGS

The above and other aspects, features and advantages of the invention will be more apparent from the following more particular description thereof, presented in conjunction with the following drawings wherein:

FIG. 1 is a perspective view of the key-shaped multi-tool device in accordance with one or more embodiments of the present invention.

FIG. 2 is a left or right side elevational view of the key-shaped multi-tool device in accordance with one or more embodiments of the present invention.

FIG. 3 is a front side elevational view of the key-shaped multi-tool device in accordance with one or more embodiments of the present invention.

### DETAILED DESCRIPTION

The present invention comprising a key-shaped multi-tool device will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

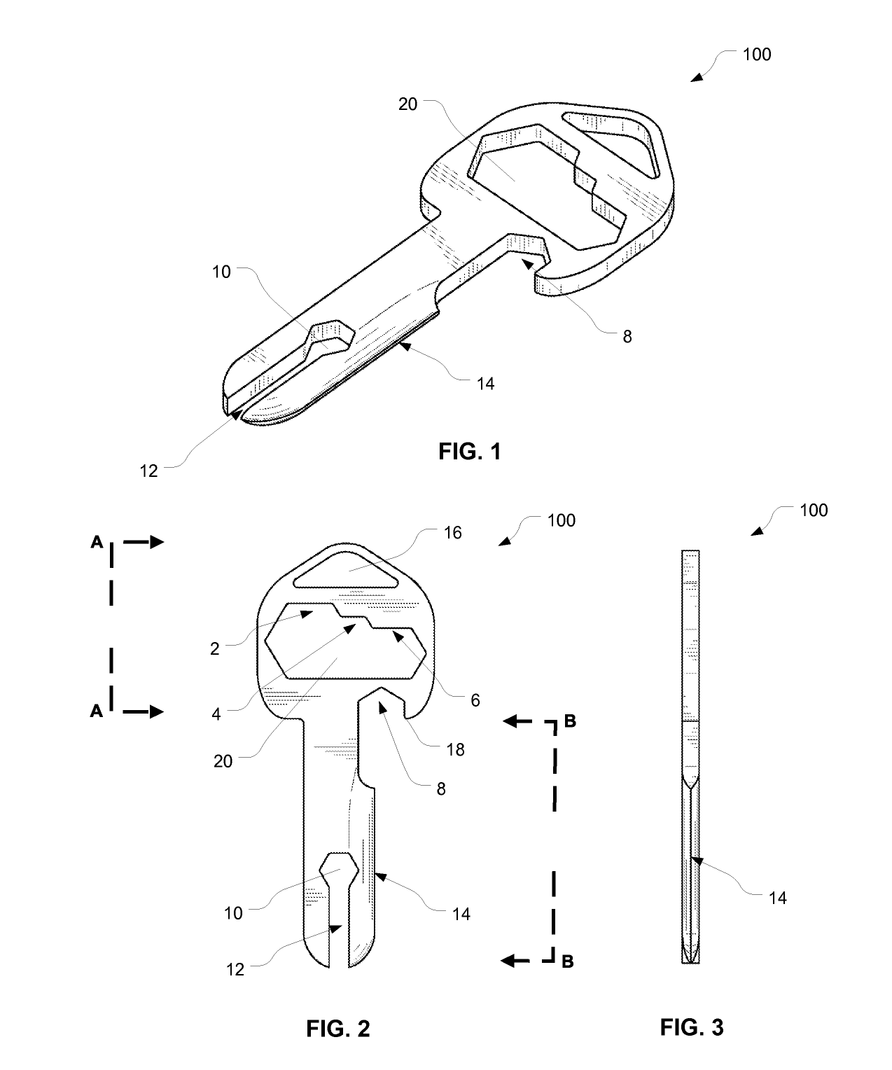

One or more embodiments of the present invention will now be described with references to FIGS. 1-3.

One or more embodiments of the present invention comprise a key-shaped device 100 with a head section A-A and a tail section B-B. Head section A-A comprises a first opening 20 with at least one section shaped to operate as a Hex wrench, e.g. sections 2, 4 and 6. For instance, section 2 may be configured as a 10 mm Hex wrench; section 4 may be configured as an 8 mm Hex wrench and section 6 may be configured as a 6 mm Hex wrench. Those of skill in the arts would appreciate that other combinations of wrench dimensions and number of sections may be included without deviating from the spirit of the invention.

In one or more embodiments, head section A-A may further comprise opening 16. Opening 16 may be used for multiple purposes, for instance, for attaching the device to a key ring, for hanging the device, etc.

In one or more embodiments, device 100 may further comprise a cavity 8 on the front side of the device and adjoining both the tail section B-B and the head section A-A. Cavity 8 extends from approximately the distal end of the tail section B-B and into the proximal end of the head section A-A. The distal end of cavity 8 is preferably shaped as a hex wrench with an outside edge 18. For instance, the distal end of cavity 8 may be configured as a 6 mm Hex wrench or any other suitable dimension. Also, the distal end of cavity 8 may take any other shape, for instance, it could be rounded, rectangular, etc. Those of skill in the arts would appreciate that other shapes and dimensions (e.g. of the Hex wrench) may be used for cavity 8 without deviating from the spirit of the invention.

The length of cavity 8, i.e. the distance from its proximal end to its distal end, may be configured to allow for multiple uses of the cavity. For instance, in one embodiment, the length of cavity 8 and the outside edge 18 may be configured such that the cavity may be used as a bottle opener. In one or more embodiments, cavity 8 may be shaped as a three-quarter oval.

In one or more embodiments, tail section B-B comprises a cutting blade 14 from approximately its proximal end to approximately the edge of cavity 8. Cutting blade 14 is preferably a semi-sharp blade such that it would be safe to touch with a person's hand and also not inadvertently cut an object. For instance, it should not cut a hole in a person's pocket if the device is placed therein such as would be the case for house and car keys. However, a cap (not shown) may be provided to cover the tail section to prevent inadvertently cutting an object.

Cutting blade 14 is preferably sharp enough such that it could be used for functions such as: a letter opener; cuticle pusher; pill splitter; lottery scratcher; seal opener; vegetable peeler; tag popper; flathead screwdriver; box opener; etc.

In one or more embodiments, tail section B-B further comprises a slot 12 with a distance approximately one-quarter the length of the tail section B-B. Slot 12 begins at the proximal end of tail section B-B and runs towards the distal end. In the illustrated embodiment, the proximal end of slot 12 is configured as a claw such that it could be used for multiple functions, for instance, as a canister lid opener, a can opener, a staple remover, etc.

In one or more embodiments, device 100 may further comprise a cavity 10 adjoining slot 12 in tail section B-B. Cavity 10 is located approximately one-third the distance from the proximal end of tail section B-B and near the mid-section of blade 14. Cavity 10 is preferably shaped as a Hex wrench. In one or more embodiments, cavity 10 may be configured as a 4 mm Hex wrench or any other suitable dimension or use. For instance, cavity 10 may be configured to be used as a bit screw grabber. Those of skill in the arts would appreciate that other Hex wrench dimensions may be used for cavity 10 without deviating from the spirit of the invention.

Device 100 is preferably made of titanium for its high strength and low weight. Those of skill in the arts would appreciate that other materials are contemplated, e.g., stainless steel etc. without deviating from the spirit of the invention.

While the invention herein disclosed has been described by means of specific embodiments and applications thereof, numerous modifications and variations could be made thereto by those skilled in the art without departing from the scope of the invention set forth in the claims.

What is claimed is:

1. A key-shaped multi-tool device comprising:
a head comprising an opening with at least one section shaped to operate as a Hex wrench;
a tail comprising a semi-sharp cutting blade and a slot from its proximal end to an adjoining second cavity, wherein the second cavity is shaped as a Hex wrench; and
a first cavity on a front side adjoining said head and said tail, wherein said first cavity is shaped for use as a Hex wrench and as a bottle opener.

2. The key-shaped multi-tool device of claim 1, wherein the at least one section in said opening is shaped to operate as a 10 mm Hex wrench.

3. The key-shaped multi-tool device of claim 1, wherein the at least one section in said opening is shaped to operate as an 8 mm Hex wrench.

4. The key-shaped multi-tool device of claim 1, wherein the at least one section in said opening is shaped to operate as a 6 mm Hex wrench.

5. The key-shaped multi-tool device of claim 1, wherein the at least one section in said opening comprises a first section shaped to operate as a 10 mm Hex wrench, a second section shaped to operate as an 8 mm Hex wrench, and a third section shaped to operate as a 6 mm Hex wrench.

6. A key-shaped multi-tool device comprising:
a head comprising an opening with at least one section shaped to operate as a Hex wrench;
a tail comprising a semi-sharp cutting blade on its front side and a slot at its proximal end, wherein the slot is shaped as a claw at the proximal end; and
a first cavity on a front side adjoining said head and said tail, wherein said first cavity is shaped as a three quarter oval and comprises an edge abutting the head and configured to be used as a bottle opener.

7. The key-shaped multi-tool device of claim 6, further comprising a second cavity adjoining said slot in said tail, wherein said second cavity is configured as a Hex wrench.

8. The key-shaped multi-tool device of claim 6, wherein the distal end of said first cavity is configured as a Hex wrench.

9. The key-shaped multi-tool device of claim 6, wherein the at least one section in said opening comprises a first section shaped to operate as a 10 mm Hex wrench, a second section shaped to operate as an 8 mm Hex wrench, and a third section shaped to operate as a 6 mm Hex wrench.
